(19) United States
(12) Patent Application Publication
(10) Pub. No.: US 2005/0137961 A1
(43) Pub. Date: Jun. 23, 2005

(54) Latency-aware asset trading system

(76) Inventors: John Edwin Thomas Brann, Hartsdale, NY (US); Neill Penney, Surrey (GB)

Correspondence Address: LAW OFFICES OF GRADY L. WHITE, LLC, 7272 WISCONSIN AVE, SUITE 300, BETHESDA, MD, 20814, US

(21) Appl. No.: 10/996,612

(22) Filed: Nov. 26, 2004

Related U.S. Application Data
(60) Provisional application No. 60/524,841, filed on Nov. 26, 2003.
(60) Provisional application No. 60/558,577, filed on Apr. 2, 2004.

(51) Int. Cl. G06F 17/60

(52) U.S. Cl. 705/37

(57) ABSTRACT

An online trading system for providers, customers and online trading servers, as well as methods of conducting online trading transactions, that incorporate processing components and steps that measure, monitor, report and utilize up-to-date network latency data to process offers to deal so that an unnecessarily large number of deals will not be refused. The systems and methods may also be used to make adjustments to the frequency and content of price quotes, based on current latency data, to improve customers' opportunity to submit offers that will arrive timely. The invention provides banks (and other liquidity providers), as well as online trading server operators, with sufficient information concerning network latencies so that price quotes issued by the banks can be “tuned” and customized so that they will not expire before the bank's customers have a reasonable opportunity to review the price quotes and submit offers to deal.

### CROSS-REFERENCE TO RELATED APPLICATIONS

This application is related to and claims priority under 35 U.S.C. § 119 to provisional application No. 60/524,841, filed Nov. 26, 2003, and provisional application No. 60/558,577, filed Apr. 2, 2004, which are both incorporated into this application in their entirety by this reference.

### FIELD OF ART

In the asset trading business, including for example the foreign exchange (“FX”) and money markets, customers execute trades through asset dealers (typically, banking institutions), who are referred to as “liquidity providers,” or simply “providers.” In a typical scenario, a customer wishing to buy, sell, lend or borrow some quantity of assets proposes a trading transaction by sending a request for price quotes (referred to as an “RFQ”) to one or more of the providers. The providers respond by returning price quotes for the proposed transaction, which indicate the prices the providers are willing to buy (or borrow) the assets, as well as the prices they are willing to sell (or lend) the assets. If a customer likes a price quote and wishes to enter into a deal with the sending provider, then the customer transmits to the provider an offer to trade assets for the price stated in the price quote (the offer is typically referred to as an “offer to deal”). If the price quote is still available (i.e., not expired) when the provider receives the customer's offer to deal, and the provider can meet other terms in the RFQ, such as the quantity ordered and the proposed settlement date, then the provider typically accepts the offer to deal, and the proposed transaction is booked and executed. In a slightly different scenario, providers may stream price quotes to customers on a substantially continuous basis without receiving a specific RFQ for price quotes, and customers may initiate a transaction by sending an offer to deal against one or more price quotes within the stream.

In today's global foreign exchange trading business, trading transactions are routinely conducted over very large interconnected computer networks, such as, for example, a corporate intranet, a secure extranet, a dedicated wide area network (WAN), or the Internet. Providers transmit price quotes for proposed trades over these interconnected computer networks to customers who may be located on the other side of the world. Thus, offers to deal responsive to these price quotes also have to travel half-way around the world.

In order to reduce the risk that a significant change will occur in the marketplace while the price quote is still available to the customer, price quotes normally have a very short lifetime (usually measured in seconds), after which they become stale or invalid, and therefore non-dealable. If a customer submits an offer to deal against a price quote after the lifetime for the price quote has expired, then the provider typically rejects the customer's offer to deal because the provider regards that price quote as stale and/or non-dealable.

Given the very short lifetime of price quotes, delays in the time required price quotes and offers to travel through the computer network and reach their destinations in far away cities can and usually do have a significant negative impact on the number of proposed trades that are accepted, booked and executed. In some cases, even a half-second delay occurring between the time a provider generates a price quote for a proposed trade and the time the provider receives an offer to deal against the quote can cause the proposed trade to be rejected. In extreme cases, the life of a price quote may expire before the price quote has even reached the customer. The customer may not realize that the price quote has expired because whatever problem in the network that caused the price quote to be delayed also delays transmission of any messages designed to inform the customer that the price quote has expired. Thus, the customer will often spend a substantial amount of time and resources reviewing and submitting offers to deal against expired and non-dealable price quotes. Such offers to deal will, of course, be rejected by the providers.

Not surprisingly, customers do not like having their offers to deal rejected. Frequent rejections by a certain provider can, over time, undermine the relationship between the customer and that provider and ultimately lead the customer to avoid making offers to that particular provider for fear that doing so will probably result in another rejection and thereby constitute a waste of time, effort and money. Providers, on the other hand, do not like rejecting legitimate offers because their livelihoods depend on executing deals, not rejecting them. Other parties involved in the business of foreign exchange trading, such as brokers and online trading portal operators, also suffer when a significant number of potential deals are needlessly killed or rejected due to transmission delays.

Nevertheless, providers cannot allow price quotes to remain valid indefinitely. Since the market is always moving and rates are always changing, providers must change their quoted rates fairly frequently in order to remain competitive with other players in the industry and still make a profit on executing trades. Generally speaking, very accurate (and therefore, more profitable) price quotes have shorter lifetimes. Accordingly, providers are always striving to provide more accurate, shorter-lived price quotes, yet not so short-lived that a large number of deals will not be rejected unnecessarily.

Large computer networks, such as the Internet, typically transmit data from a source computer to a destination computer by encapsulating the data into data packets and moving the data packets along a path (or “route”) comprising a potentially very large number of intermediate nodes (i.e., computers, routers, switches, bridges and gateways) attached to the network. Thus, each data packet is moved in a series of “hops” from one intermediate node to the next until it reaches its final destination, where it is then combined with other data packets (which may have arrived via a different route) to re-assemble the data. At each intermediate node (between each hop), a certain amount of route processing is required to determine where a data packet should be sent next as it travels through the network. Typically, this route processing requires examining and, sometimes actually changing, the header information in each data packet, which always takes some finite amount of time to complete. The more hops there are between the source and destination nodes, and the larger the data packets are, the more time it will take for each data packet to be transmitted.

The combined time intervals required by each node to perform the route processing described above is usually referred to as “the latency time,” or simply, “latency.” Latency, which is typically considered a synonym for delay, is an expression of how much time it takes for a packet of data to get from one designated point in the network to another. In some contexts (such as at AT&T, for example), latency is defined as the roundtrip time required for a data packet to leave the sender, reach the recipient and return to the sender. Besides route processing, other contributors to network latency include: propagation (the time it takes for a packet to travel between one place and another at the speed of light); transmission medium issues (a large data packet will take longer to receive and return than a short data packet, regardless of whether the medium comprises standard wiring, optical fiber, wireless links, or some other kind of link); and data storage delays (typically, data packets temporarily stored on hard disks at the intermediate nodes, as well as at each end of the journey).

When online trading transactions are conducted over a very large computer network, such as the Internet, latency problems necessarily become a significant factor in the rate of rejections and, therefore, the overall performance and success of the online trading system. Testing has shown, for example, that roundtrip latencies for Internet transmissions between New York City and cities in Europe typically take anywhere from 100 to 200 milliseconds. Roundtrip latencies between New York City and cities in the Pacific Rim are on the order 400 to 600 milliseconds. Roundtrip latency for communications between New York City and cities in the Middle-East or Australia have been known to be longer than a second. If a provider is sending out foreign exchange price quotes that have lifetimes of only 2 to 5 seconds, then the latencies described above constitute significant slices of time that is essentially “lost” or “wasted” during the 2- to 5-second lifetime of any particular price quote. When one adds to these latency figures the time required for the customer to see, consider and respond to the price quotes, and the time required for the online trading system to process, store, log and audit the trading terms and instructions of the parties, then it is not difficult to understand why so many price quotes may expire before an order to deal on an issued price quote is received and processed.

Because of their extremely fine lifetimes, online foreign exchange trading transactions conducted over the Internet are particularly sensitive to latency problems. Transmission delays as small as a second or less can result in substantial and unacceptable increases in the number of offers to deal that will be refused. If, for example, the online trading network requires one second to convey price quotes from a particular provider to a set of potential customers, and the average lifetime of those price quotes is five seconds, then it is not unrealistic to expect that as much as twenty percent (20%) of the offers to deal against the provider's price quotes will be rejected because they will be received after the five-second lifetime has expired. Even as new technological advances in computer networking equipment come online and network communication methods become faster and more efficient, latency is an inherent physical limitation that will never disappear entirely.

The latency problem associated with large interconnected computer networks is further complicated by its variability. For example, the latency associated with communications over any particular link in a network is usually very different from the latency associated with any other link in the network. Moreover, the latency for communications using any particular network link can, and usually does, vary significantly, depending, for example, on the time the communications are sent, the level of traffic congestion on the link at the moment of transmission, the quality and physical integrity of the link, and a host of other important network performance factors. Notably, these important network performance factors are usually outside the control of the providers, customers and brokers participating in the foreign exchange transaction—especially when the computer network is the Internet.

Accordingly, there is a need for an online trading system that takes latency problems into account as it determines whether offers to deal received for those price quotes will be accepted or refused. There is further need for this “latency-aware” online trading system to operate effectively regardless of the size of the network, or whether such network comprises data communications links that form part of a corporate intranet, an extranet, a dedicated WAN, the Internet, or some combination of these networks.

### SUMMARY OF THE INVENTION

The present invention addresses this need by providing online trading systems for providers, customers and online trading server operators, as well as methods of conducting online trading transactions, that incorporate processing components and steps that measure, monitor, report and utilize up-to-date latency data to process offers to deal so that an unnecessarily large number of deals will not be refused solely due to latency problems in the network. The systems and methods may also be used to make adjustments to the frequency and content of price quotes, based on current latency data, to improve customers' opportunity to submit offers that will arrive timely.

In one aspect of the invention, there is provided a computerized provider trading system for market makers, banks, brokers and other provider institutions to generate and transmit price quotes, and to accept and process offers to deal submitted against those price quotes over a computer network. Among other things, the provider trading system includes a quote generator, a latency data processor and an order processor. The quote generator in the provider trading system transmits price quotes to one or more customer trading systems attached to the computer network. The price quotes have specified lifetimes, which, upon expiration, will render the price quotes stale or invalid, and therefore non-dealable. The latency data processor determines the latency for communications between the provider trading system and the customer trading systems uses this information to establish a window of time within which offers to deal will be considered timely. The latency may be determined by receiving the information from another computer system configured to calculate and report such information, or, alternatively, it may be periodically measured by the provider trading system using methods described in more detail below. In preferred embodiments, latency data is stored in reports that are periodically distributed throughout the computer network.

Since the provider trading system and the customer trading systems may be configured to communicate with each other through an intermediate online trading server connected to the network, the latencies obtained or calculated by the latency data processor also may include the time required for the intermediate trading server to perform functions such as order logging, auditing, security checks and temporary data storage. The latencies may also include the additional time required for the provider trading system and the customer trading systems to transmit and receive data to and from the online trading server. The combination of provider trading system latency, online trading server latency and customer trading system latency is sometimes referred to as the overall “end-to-end” latency.

The order processor receives offers to deal from the customer trading system responsive to the price quotes and rejects the offer to deal for arriving too late if the offer to deal is received after the expiration of a specified period of time (i.e., an “acceptance window”), which is calculated to take current latency problems between the counterparties into account.

In some embodiments, the acceptance window is calculated to be equal to the sum of the latency and the price quote's lifetime. In other words, the acceptance window will remain open for a period of time that is longer than the price quote's lifetime by an amount equal to the latency. In other embodiments, if a first price quote is rejected by the order processor due solely to a network latency problem, the system will recognize this fact and will send out subsequent price quotes just a little bit sooner than it otherwise would, or just a little bit more frequently, to give customers more time and opportunity to submit offers to deal before the acceptance window closes. In effect, this amounts to giving the price quote a head start on the acceptance window so that the price quote will have already arrived at the customer's trading system by the time the acceptance window opens. As a result, the period of time in which the acceptance window is open will more closely correspond to the period of time in which the customer has access to the price quote. In still other embodiments, the system will delay the opening of the acceptance windows for price quotes, responsive to the determinations of the latency data processor, so that the acceptance window will not open until the time period in which the provider trading system is most likely to receive an offer to deal from the customer.

In each of the above-described embodiments, the latency data processor provides the information the system needs in order to determine just how much earlier, or just how much more frequently, the price quotes need to be sent out to avoid refusing offers due solely to latency issues in the network. Offers to deal may still be rejected for reasons other than latency. For example, the customer may have insufficient credit or authority to carry out the proposed transaction. But the invention ensures that offer to deal will not be rejected solely due to delays caused by network latency problems.

In another aspect of the invention, the latency data controller and order processor are configured to reside and operate on the intermediate online trading server instead of the provider's trading system. In addition to the latency data processor and order processor functions described above, trading servers configured to operate according to this aspect of the invention include a customer interface for communication with a customer trading system connected to the computer network, a provider interface that receives a price quote from a provider trading system and a quote distributor, which transmits the price quote to the customer trading system via the customer interface. The order processor receives offers to deal responsive to the price quotes and rejects offers to deal if they are not received prior to expiration of a specified acceptance window. Again, the acceptance window may be configured to be equal the original lifetime of the quote, an adjusted or extended lifetime that incorporates the latency (as determined by the latency data processor), a sum of the original lifetime and the latency, or some other time period.

Optional elements of the online trading server aspect of the invention also include an order logging database to store booking and execution details related to trades, a relationship database to store counterparty relationship data, a customer interaction management console configured to monitor latency values and the rate of refusals for the provider and customer trading systems, all of which are discussed in more detail below. The online trading server also includes a status display configured to display latency values to a system manager or customer service agent.

In all of the various aspects of the invention, the latency data associated with any particular provider-to-customer connection may be stored, for example, in a latency database on the provider's trading system, a database on the customer's trading system, a database on the intermediate online trading server system, or at all three locations. The latency data is then made available to the various trading components in the system or network that are responsible for processing offers to deal. So, for example, a provider system configured to operate according to the principles of the present invention may establish a larger acceptance window for a particular price quote destined for a particular customer to account for the fact that there will necessarily be a larger lag or delay in transmitting information to and receiving information from that particular customer.

Although the price quotes may still be replaced say, every five seconds, but the provider system may add a smidgeon of time to the acceptance window now and again to deal with the latency problem. Alternatively, the provider trading system may be configured to send the next price quote just a little bit sooner than it otherwise would (i.e., before the last price quote expires), or otherwise increase the frequency of price quotes transmitted to that customer trading system.

Accordingly, several objects and advantages of the invention are apparent. For example, it is one object of the invention to provide banks (providers), as well as online trading servers, with sufficient information concerning network latencies so that price quotes issued by the banks can be “tuned” so that they will not expire before the bank's customers have a reasonable opportunity to review the price quotes and submit offers to deal. An advantage is that fewer offers to deal will be refused for arriving too late. Banks are able to decrease their rate of rejections and thereby achieve a higher level of satisfaction for their customers. The more offers accepted, the more money the bank will make. Armed with the information provided by the invention, banks can optimize the lifetimes of price quotes for individual customers based on those customers' individual latencies. Further objects and advantages of the invention will become apparent from a consideration of the drawings and ensuing description.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include exemplary embodiments of some of the various forms of the invention. In these drawings:

FIG. 1 contains a high-level block diagram illustrating the major functional components of one embodiment of the invention, wherein a large portion of the latency data processing and order processing provided by the present invention takes place on a provider trading system.

FIG. 2 contains a diagram showing the various types of latency periods in a network.

FIG. 3 contains a timeline illustrating the typical timing sequences associated with trading systems found in the prior art.

FIGS. 4, 5 and 6 contain timelines illustrating, by way of example only, some of the timing sequences associated with trading systems configured to operate according to embodiments of the present invention.

FIG. 7 contains a high-level flow diagram illustrating the steps that might be performed in embodiments of the invention, such as, for example, the provider trading system depicted in FIG. 1.

FIG. 8 contains a high-level block diagram illustrating the major functional components of another embodiment of the invention, wherein a larger part of the latency data processing and order processing takes place on an intermediate online trading server.

FIG. 9 contains a high-level flow diagram illustrating the steps that might be performed in another embodiment of the invention, such as the intermediate online trading server depicted in FIG. 8.

### DETAILED DESCRIPTION OF PREFERRED EMBODIMENTS

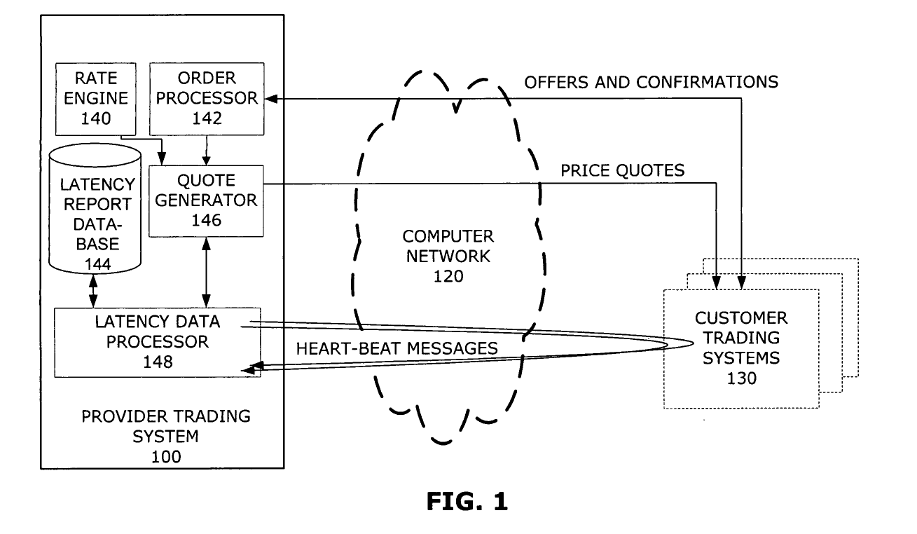

With reference to FIGS. 1 through 9, a detailed discussion of exemplary embodiments of the invention will now be presented. Notably, the invention may be implemented using software, hardware, firmware, or any combination thereof, as would be apparent to those of skill in the art upon reading this disclosure.

FIG. 1 contains a high-level block diagram illustrating the major functional components of a provider trading system 100 configured to execute trades according to an embodiment of the present invention. In this example, most of the latency data and offer to deal processing takes place on the provider trading system 100. As will be described in more detail below, alternative embodiments, wherein a larger portion of the latency data processing and offer to deal processing takes place on a computer system other than the provider trading system, such as an intermediate online trading server, are also possible.

As shown in FIG. 1, provider trading system 100, which may be implemented on one or more personal computers, mini-computers or mainframes, is configured to communicate with one or more remote customer trading systems 130 over a computer network 120, such as the Internet. In preferred embodiments, provider trading system 100 comprises a quote generator 146, a latency data processor 148 and an order processor 142. Quote generator 146 is configured to produce a price quote for customer trading system 130 and transmit the price quote to customer trading system 130 over computer network 120. In order to accomplish this, provider trading system 100 may include or be connected to an optional rate engine 140, which supplies quote generator 146 with up-to-date market pricing data for trades involving certain kinds of assets. Rate engine 140 may reside on provider trading system 100 (as shown in FIG. 1), or it may be connected to provider trading system 100 through computer network 120, for example, or alternatively, through one or more other computer networks (not shown) to which provider trading system 100 may be attached.

Typically, the price quote produced by quote generator 146 is configured to remain valid for only a short period of time (say, three, four or five seconds, for example) in order to minimize the risk that the market for the assets which are the subject of the price quotes has not changed substantially while the price quote is still available to the customer. Thus, the price quote produced by quote generator 146 will have a limited lifetime, after which it will become non-dealable. At the discretion of the operator of provider trading system 100, the lifetime of any particular price quote may also depend, for example, on the assets involved, the particular customer to which the price quote will be sent and/or a variety of other factors which may be significant to the parties.

Latency data processor 148, which may be implemented, for example, via a standalone software program or a combination of software programs and function calls executable by a microprocessor running on provider trading system 100, determines the latency for communication with the remote customer trading systems 130. In preferred embodiments, latency data processor determines this latency by sending one or more simple “are you there” messages (called “heartbeat messages”) to each remote customer trading system 130 connected to provider trading system 100 via computer network 120. The heartbeat messages are configured to elicit some kind of response from the customer trading system to which it was sent. Such response may comprise simply “bouncing” the heartbeat message back to provider trading system 100, or, alternatively, sending some other kind of message, data or report. Provider trading system 100 then monitors incoming messages to determine if and when such responses are received from the customer trading systems 130.

When a response is received, provider trading system 100 measures the interval of time that has elapsed between sending the heartbeat message and receiving the response. One way of measuring this interval of time, although not the only way, is to record the exact time at which each heartbeat message is transmitted, the exact time at which each response is received, and calculate the difference, thereby providing the roundtrip travel time (i.e., the latency) for data communications between provider trading system 100 and each customer trading system 130. For easier tracking and matching of heartbeat messages and responses, provider trading system 100 may be configured, for example, to embed each outgoing heartbeat message with a time stamp (typically using a millisecond scale clock value) indicating the exact time at which the heartbeat message was sent, as well as information identifying the customer trading system to which it was sent.

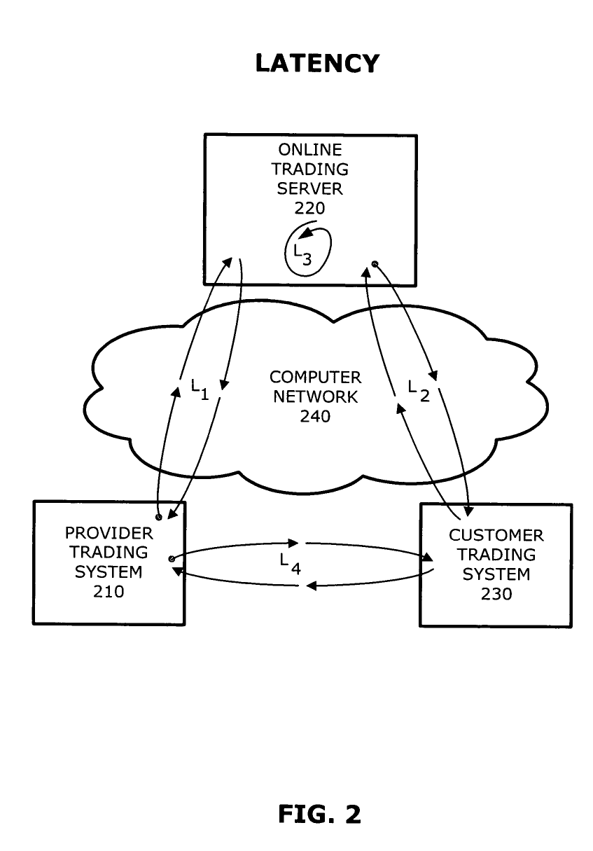

Depending on the specific requirements of the system, the latency associated with any two nodes on a computer network may be measured in a number of different ways. FIG. 2 illustrates, by way of example, a couple of the ways latency may be measured in a computer network used for trading assets online. FIG. 2 shows a system whereby a provider trading system 210 and a customer trading system 230 indirectly communicate with each other through computer network 240 and online trading server 220. In FIG. 2, L₁ represents the roundtrip travel time required for information (carried by network data packets) to travel from provider trading system 210, through various nodes in computer network 240, out to online trading server 220, back to the network, and, finally, back again to provider trading system 210. L₂ represents the roundtrip travel time required for information to travel from customer trading system 230, through nodes in computer network 240, out to online trading server 220, back through the computer network, and out again to customer trading system 230. If the data packets carry information related to trading assets (for example, price quotes, offers to deal, trade execution details, confirmations and acceptance messages), then L₃ represents the time required for online trading server 220 to perform functions such as logging, auditing, verifying, storing and matching asset trading instructions and responses as the information passes through it. In this scenario, the overall “end-to-end” latency (L) for communications between provider trading system 210 and customer trading system 230 may be thought of as the sum of L₁+L₂+L₃. In other scenarios, provider trading system 210 and customer trading system 230 may be configured to transmit certain messages and trading instructions directly between each other (i.e., along the path designated L₄ in FIG. 2) and not utilize any links in computer network 240 or online trading server 220. In this case, the latencies associated with communicating through the computer network (L₁+L₂) and online trading server latency (L₃) would not be considered to be a factor in the latency calculation and therefore would not be used by the latency data processor 148 to determine the overall latency.

Returning again to FIG. 1, latency data processor 148 may be configured to use latency determinations to generate latency reports, which are stored in optional latency report database 144 residing on provider trading system 100. In preferred embodiments, a latency report comprises three different numbers: a short-term average latency, a medium term average latency and a long-term average latency. Three average latency figures are preferred because individual latencies may vary substantially due to changes in the network that affect the connections between the data transmission endpoints. The short-term average latency indicates the most recent roundtrip travel time for data packets traveling between parties. This number may be significantly skewed by individual outlying values caused by the most recent network connection or transmission problems. The medium term average latency provides a number that is somewhat less skewed by the most recent connection or transmission problems (compared to the short term average latency number). The long-term average latency may be viewed as a baseline, which tells users and/or processors what the latency picture looks like with a large number (typically all) of the outlying values discounted (or averaged out). On a connection operating under perfect conditions, the short-term, medium-term and long-term averages be roughly the same value.

Accordingly, latency data processor 148 may be configured to send a plurality of heartbeat messages to customer trading system 130, to receive a plurality of responses, an to calculate average short-term, medium-term and long-term latencies based on the intervals of time that elapses between sending each heartbeat message and receiving each response. Preferably, latency data processor 148 uses these averages to periodically generate up-to-date latency reports for all customer trading systems that will receive price quotes from provider trading system 100, and also periodically transmits these updated reports to customer trading system 130, as well as other computer systems (not shown in FIG. 1) attached to computer network 120. The other computer systems may use the latency data, as appropriate, to coordinate and control their own communications with provider trading system 100. One efficient way to distribute latency reports throughout the network is to embed the current latency reports in outgoing heartbeat messages, along with the timestamps to be used for calculating new latency averages.

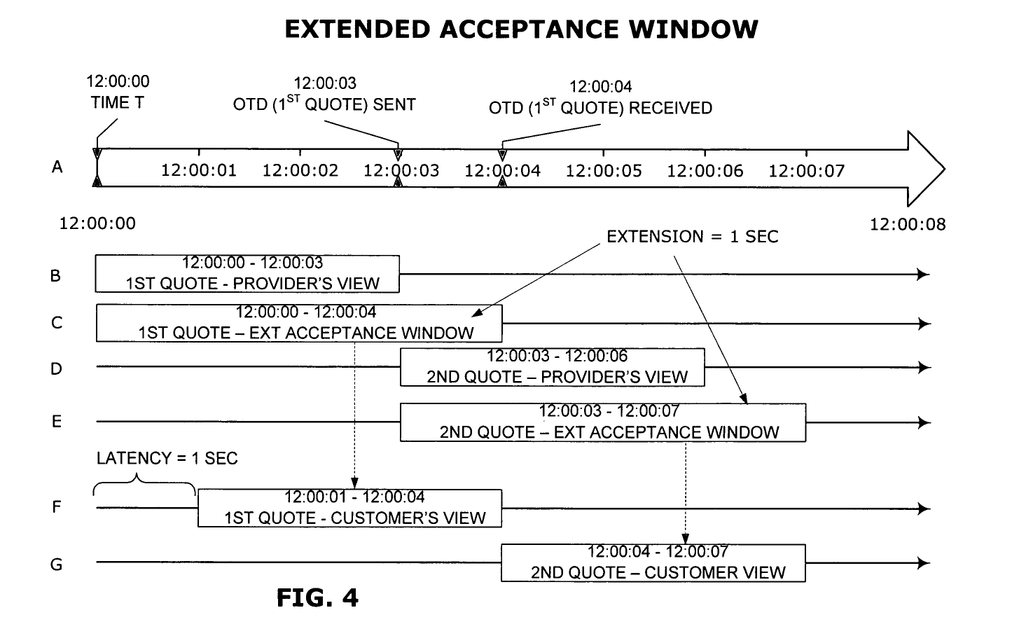

If customer trading system 130 responds to a price quote sent by quote generator 146 by submitting an offer to deal, order processor 142 receives the offer to deal and determines whether it should be rejected as having arrived too late relative to the price quote's lifetime. In deciding whether the offer to deal arrived too late, order processor 142 takes into account not just the price quote's lifetime, but also the latency determination made by latency data processor 148. Accordingly, order processor 142 is configured to retrieve (from latency data processor 148 or from optional latency report database 144, for example) the latest latency report for the customer trading system that sent the offer to deal. Order processor 148 will then use the report, along with the price quote's lifetime, to establish an acceptable window of time within which the offer to deal must arrive in order to avoid rejection. Various ways in which the order processor 148 establishes this acceptable window of time are discussed in detail below with reference to FIGS. 4, 5 and 6.

If the offer to deal arrives before the acceptable window of time closes, then order processor 148 will not reject the offer to deal for having arrived to late (although the offer to deal may be rejected for other reasons, such as insufficient credit). In this case, the order processor may also be configured to send to customer trading system 130 a rejection notice. If the offer to deal is not rejected, then order processor 148 is further configured, in preferred embodiments, to proceed to executing a trade based on the offer to deal (assuming there are no other problems with the offer) and to send customer trading system 130 a confirmation notice and/or a trade execution detail.

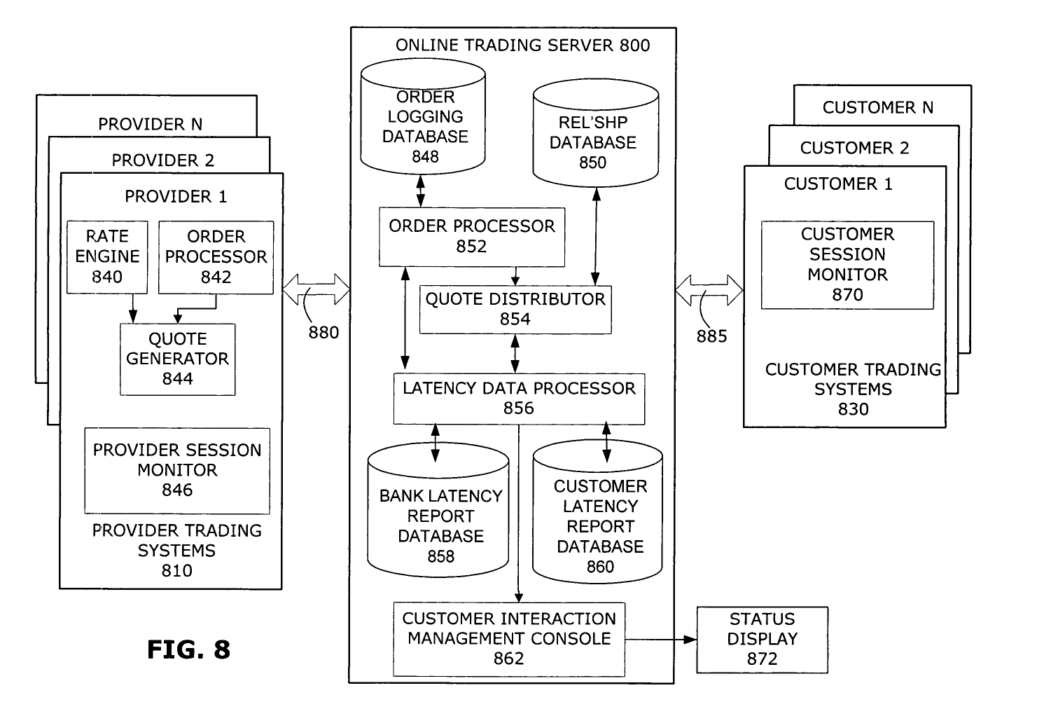

Although FIG. 1 shows the latency data processor and latency report database residing on provider trading system 100, it should be apparent to those skilled in the art, upon reading this disclosure, that these components of the invention (as well as part or all of the functions they perform) may also reside on the other computer systems in the network, such as customer trading system 130 or an intermediate online trading server (an example of this alternative is discussed below with reference to FIG. 8). In this case, the latency reports are created by customer trading system 130 or the intermediate online trading server, which do so by measuring the interval of time required for time stamped data packets to travel through the network to provider trading system 100, and back from whence it came. This might be useful, for example, in cases where another node provides a faster, more efficient or less costly ways of processing heartbeat messages and time stamps (perhaps because the other node is capable of dedicating more resources to this specific task). Accordingly, another way for a latency data processor 148 on provider trading system 100 to determine the latency for communications with a particular customer trading system or intermediate online trading server is to receive a latency report from another node in the network. Such latency reports may even be transmitted to provider system 100 along with the request for quotes that prompted provider trading system 100 to produce price quotes for customer system 130 in the first place.

Establishing an Acceptable Window of Time to Receive Offers

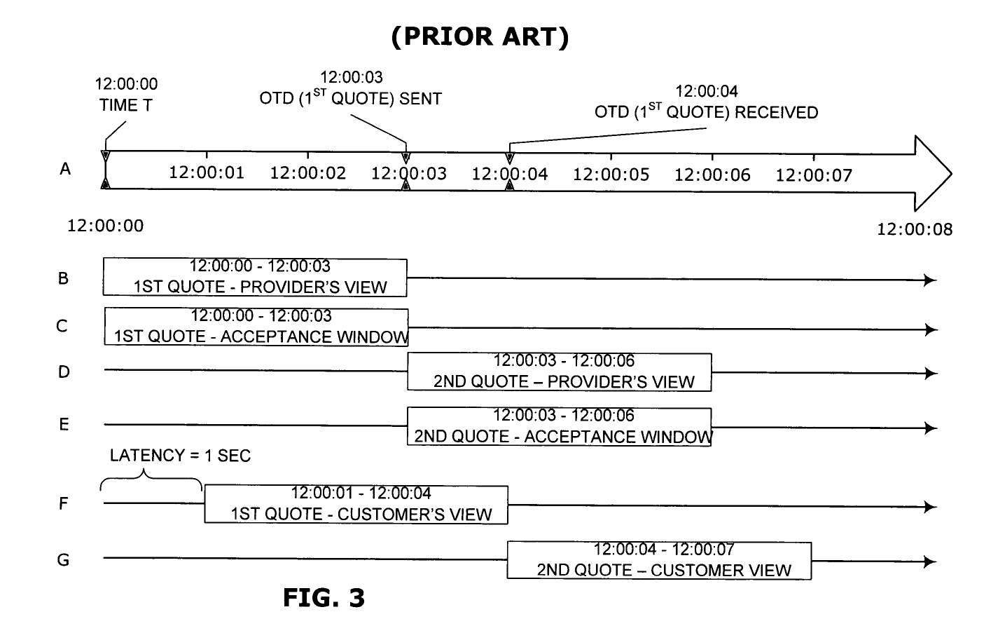

FIG. 3 contains a diagram with seven timelines, which illustrate the typical sequence of events for prior art trading systems, which do not take network latency into account when refusing offers to deal. The timelines shown in FIG. 3 depict what occurs over a slice of time which begins at 12:00:00 (Time T) and ends seven seconds later at 12:00:07. Timeline A shows when the offer to deal is sent by the customer and received by the provider. Timelines B, C and D show, respectively, from the provider's perspective, the lifetime of the first price quote (timeline B), the acceptance window of the first price quote (timeline C), the lifetime of the second price quote (timeline D) and the acceptance window of the second price quote (timeline E). The last two timelines (timelines F and G) of FIG. 3 show, from the customer's perspective, when the first and second quotes arrive and appear to be available for dealing. Both the first and second quotes have lifetimes of three seconds.

As shown in FIG. 3, the provider transmits the first price quote to the customer at 12:00:00 (see timeline B). Since the lifetime of the first quote is three seconds, the first quote will only be valid until 12:00:03. Simultaneously with transmitting the first quote, the provider begins monitoring his network connection for offers to deal based on the first quote and will not reject offers to deal that arrive before the first quote's lifetime expires. Thus, the acceptance window for the first quote (shown in timeline C) corresponds exactly to the lifetime of the first quote (shown in timeline B) and ends at 12:00:03.

However, since there is, in this case, a one-second latency (delay) between the time the provider transmits the first quote and the time it is seen by the customer, it appears to the customer that the first quote is available from 12:00:01 to 12:00:04 (see timeline F in FIG. 3). Therefore, by the time the customer sees the first quote, at 12:00:01, one-third of the time allotted submit a valid offer to deal for the first quote (see the acceptance window of timeline C) has already expired. More importantly, by the time the customer sends an offer to deal on the first quote at 12:00:03 (see timeline A), the acceptance window for offers to deal on the first quote is already closing (timeline C). By the time the offer to deal arrives at the provider's system, it is 12:00:04, and the acceptance window has already been closed for a full second. In fact, by the time the provider receives the offer to deal on the first quote, the replacement price quote (i.e., the second price quote) is already one second old. Consequently, and through no fault of his own, the customer's offer to deal for the first quote will be rejected solely due to latency. Unless the provider is willing to issue price quotes with longer lifetimes, or the customer finds a way to send offers to deal almost as soon as a price quote appears on his system, a large number of offers to deal will be summarily rejected for no other reason other than the latency problems inherent in the computer network.

FIGS. 4, 5 and 6 contain timelines illustrating, by way of example only, some of the solutions used by the present invention to establish more appropriate acceptance windows for offers to deal, and thereby avoid the problems illustrated by FIG. 3. In the first example, illustrated by FIG. 4, the acceptance windows for the first and second quote are extended by an amount of time equal to the latency for this particular customer, as determined by latency data processor 148 in FIG. 1. While the acceptance window for first price quote will still open at 12:00:00, it is extended in an amount equal to the latency (1 second). Thus, the length of the extended acceptance window is equal to the sum of the first price quote's lifetime (3 seconds) and the latency (1 second), or 4 seconds, which runs from 12:00:00 (Time T) to 12:00:04 (Time T plus the lifetime plus the latency) (See timeline C in FIG. 4). Consequently, the customer's offer to deal, which arrives at the provider's system at 12:00:04, arrives before the extended acceptance window is closed, or at least at the same time it is closing, and not after it has already closed. The order processor is programmed to accept offers to deal (and not reject them) if they are received at or before 12:00:00. Similarly, the acceptance window for the second price quote (shown in timeline E of FIG. 4) is also extended by an amount equal to the latency, which should give the customer a better chance of submitting an offer to deal that will arrive at or before 12:00:07, which is the time the acceptance window for the second quote closes.

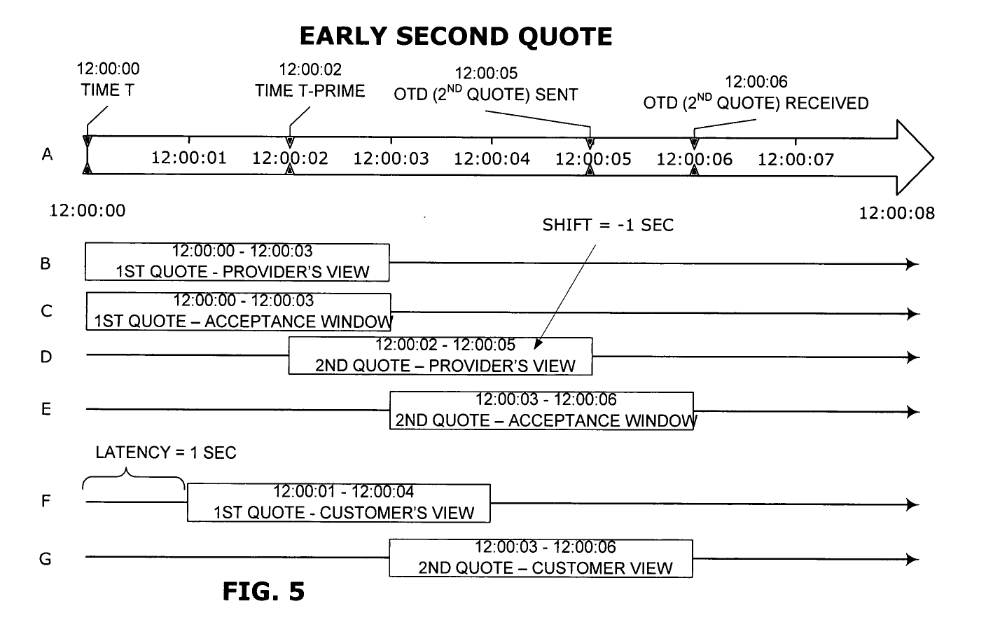

FIG. 5 illustrates another choice made possible by the present invention. It is not unusual for the latency associated with communications with a customer to vary substantially depending, for example, on fluctuations in network congestion due to a larger or smaller number of transactions occurring at particular times of day. Since systems operating according to the present invention constantly measure latency as it changes, they are capable of recognizing that a gradual or sudden increase in rejections may in fact be due to a gradual or sudden increase in latency values. When this happens, the system may be configured to automatically extend the acceptance windows for price quotes, as described above with reference to FIG. 4, or, alternatively, to send out the next price quote (or the next few price quotes, as the case may be) sooner than it otherwise would have (in effect, giving the price quote a “head start”) so that the customer will see the price at about the same time the acceptance window opens. Accordingly, and as shown in FIG. 5, the second price quote, which ordinarily would have been transmitted to the customer when the first price quote expired at 12:00:03, is instead transmitted earlier at a time T-prime (see timeline D in FIG. 5), where time T-prime is equal to time T (12:00:00 in this case) plus the difference between the lifetime of the second quote (3 seconds) and the latency (1 second). Thus, in the example shown in FIG. 5, the second price quote is transmitted at 12:00:02 (instead of 12:00:03) and arrives at the customer's system at the same time the provider trading system opens the acceptance window for the second price quote (i.e., at 12:00:03). The acceptance window for the second price quote (timeline E) now runs from 12:00:03 to 12:00:06 and corresponds precisely with the timeframe in which the customer has access to the second price quote (timeline G). Now, if the customer sends an offer to deal for the second price quote 2 seconds after it arrives (i.e., at 12:00:05) and it arrives at the provider's system no later than 12:00:06, it will arrive in time to avoid an automatic rejection.

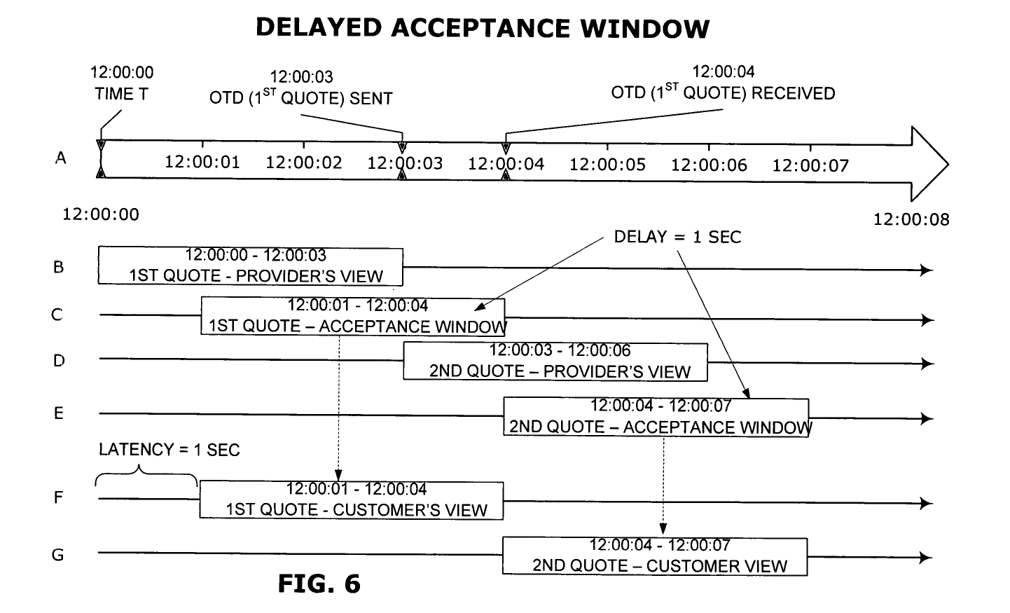

FIG. 6 illustrates yet another choice made possible by the invention for dealing with the latency problem illustrated in FIG. 3. Rather than extending the acceptance window or sending out subsequent price quotes earlier, systems configured to operate according the present invention may instead be configured to delay the acceptance window by an amount of time equal to the calculated latency for the customer. As illustrated in FIG. 6, the acceptance window for the first price quote (shown on timeline C) and the acceptance window for the second price quote (shown on timeline E) are delayed by an amount of time equal to the calculated latency (1 second in this case) so that they correspond to the timeframes in which those price quotes are seen by the customer (timelines F and G). As with the other solutions, the correspondence between the acceptance windows and the customers viewing of the quotes increases the customer's opportunity to submit an offer to deal that will arrive in time to avoid an unnecessary rejection.

Using the methods and formulas described above, the acceptance windows (i.e., the timeframes within which offers to deal against price quotes will not be rejected as having arrived too late) may be specifically tuned and customized for individual customers depending on the latencies existing for communications between those customers and the provider. As a result, even if the provider trading system is configured to send or stream the same price quotes to multiple customers simultaneously, each of those customers may be intentionally subjected to different acceptance windows based on individual customer latencies, as calculated and stored, for example, in the provider trading system's latency report database. Therefore, with the help of the present invention, the provider does not have to risk providing price quotes with arbitrarily long lifetimes in order to give the customers with the longest latency delays a fair opportunity to respond. Instead, providers can dynamically tune acceptance windows so that, in effect, all of the provider's customers will have the same opportunity to submit timely offers to deal, regardless of their individual latencies.

some embodiments, it may be necessary or desirable to modify the price quotes, responsive to the determinations made by the latency data processor, prior to transmitting the price quotes to the customer trading system, in order to compensate the provider for the increased market risk associated with the provider's decision to shift or extend the acceptance windows for those price quotes. For instance, the provider may change the price component and/or increase the spread components of price quotes in exchange for making those price quotes available to certain customers just a little bit longer than it otherwise would.

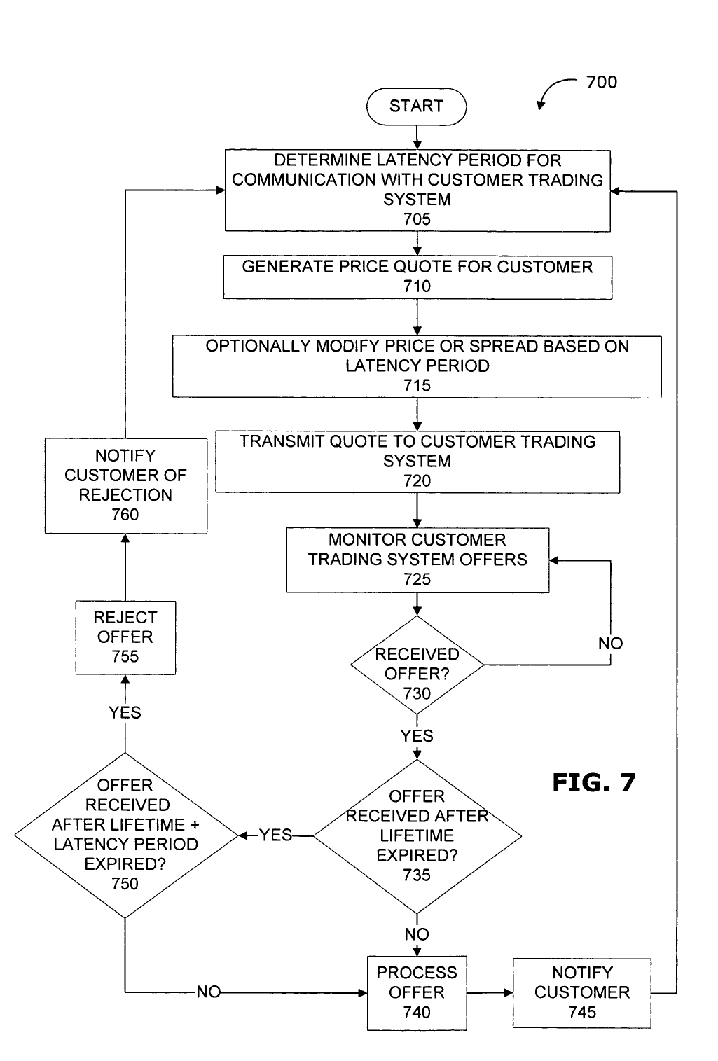

FIG. 7 contains a high-level flow diagram 700 illustrating the steps that might be performed by a provider trading system configured to operate in accordance with embodiments of the invention, such as the system depicted in FIG. 1 and described above. As shown in FIG. 7, the process typically begins (at step 705) by determining the latency period for communication with a particular customer trading system. Next, at step 710, the system generates a price quote to be transmitted to the customer trading system. Alternatively, systems configured to operate according to the principles of the invention may generate the price quote first and then determine the latency, or perform these two steps simultaneously. Then, at the option of the operator, the provider trading system may modify the price quote prior to transmitting it to the customer trading system (step 715). The price quote is transmitted to the customer trading system at step 720. Then the system monitors incoming offers (steps 725 and 730) and, when an offer is received, checks to see if it was received after the lifetime of the price quote has expired (step 735). If not, then the offer will typically be reviewed and processed (at step 740) to determine if it meets other criteria used by the provider trading system to determine whether to accept or reject an offer to deal. Typically, if the offer to deal is accepted, a confirmation notice is sent to the customer trading system (step 745) and processing returns to step 705, where the system again measures the current latency.

If it is determined at step 735 that the offer to deal was received after the lifetime expired, then the system checks to see if an amount of time equal to the sum of the lifetime and latency has expired (step 750). If the answer is no, then the offer to deal was received within an acceptable window of time, and processing continues at step 740, where the offer to deal is processed according to criteria other than the having to be received during the established acceptance window. If, on the other hand, it is determined at step 750 that the offer to deal was received after the sum of the lifetime and the latency has expired, then the offer to deal did not arrive during the acceptance window and the offer is rejected for this reason (step 755). Preferably, the customer is then notified about the rejection (step 760) and processing returns again to step 705, wherein the current latency values are measured and updated.

FIG. 8 contains a high-level block diagram of an online trading server 800 for executing trades on a computer network in accordance with the invention. As shown in FIG. 8, online trading server 800 comprises customer interface 885, provider interface 880, latency data processor 856, quote distributor 854 and order processor 852.

Customer interface 885 (typically an Internet data communications channel) is configured to convey information, such as price quotes, offers to deal, confirmation and rejection notices, as well as other trading instructions and notices, back and forth between online trading server 800 and one or more customer trading systems (shown in FIG. 8 as customer trading systems 830). Customer trading systems 830 are operated by customers 1 through N. Provider interface 880 is configured to convey similar information and instructions back and forth between online trading server 800 and one or more provider trading systems (shown in FIG. 8 as provider trading systems 810). Provider trading systems 810 are operated by providers 1 through N. Provider interface 880 and customer interface 885 may be implemented using various known communications devices, such as network interface cards, cables, transmitters and receivers, and provide data communication capability between online trading server 800, provider trading systems 810 and customer trading systems 830 over a communication network, such as the Internet (not shown in FIG. 8). In some embodiments, however, provider network interface 880 and customer network interface 885 may be configured to provide data communications capability for a dedicated local or wide area network connection, a corporate intranet or any other type of interconnected computer network. Wireless data communication devices may also be employed to implement provider interface 880 and customer interface 885.

Preferably, the provider trading systems 810 connected to online trading server 800 include a rate engine 840, an order processor 842 and a quote generator 844, which all operate substantially in accordance with the operation of rate engine 140, order processor 142 and quote generator 146 discussed in detail above with reference to FIG. 1. In this case, however, the latency data processor (shown in FIG. 8 as latency data processor 856) resides on online trading server 800 instead of on the provider trading system. Quote generator 844 on provider trading systems 810 is configured to generate and transmit price quotes having certain lifetimes to online trading server 800 via provider interface 880. The price quotes may be delivered in response to specific requests for quotes or as part of a continuous stream of quotes.

Recognizing that the price quote or price quote stream is destined for a particular customer trading system, latency data processor 856 on online trading server 800 determines a latency for communication between the provider trading system that sent the price quote and the customer trading system to which the price quote is directed. This may be accomplished, for example, by measuring the intervals of time required for provider trading systems 810 and customer trading systems 830 to respond to time stamped heartbeat messages periodically transmitted to those systems from latency data processor 856 on online trading server 800.

To facilitate the process of bouncing time stamped heartbeat messages off of provider trading systems 810, preferred embodiments of the invention include a provider session monitor 846, which resides on each one of the provider trading systems 810, and which is configured to monitor, receive and respond to heartbeat messages transmitted from online trading server 800. Typically, the provider session monitor 846 comprises a software program running in the background on the provider trading system. Similarly, each one of the customer trading systems 830 will also be equipped with a customer session monitor 870, which performs the same heartbeat monitoring functions for customer trading systems 830.

Quote distributor 854 transmits the price quotes to customer trading systems 130 via customer interface 885. In some embodiments, the quote distributor 854 is further configured to convey the same price quotes to a plurality of customer trading systems 830, thereby establishing a “one-to-many” transmission of price quotes from a single provider on the one hand and multiple customers on the other. In such cases, quote distributor 854 may need to determine which customer trading systems should receive the price quotes based on information previously received from customer trading systems 130. Thus, quote distributor 854 may be configured, for example, to receive requests for quotes from the one or more customer trading systems 130, each request containing a set of requirements or preferences for trading assets. Typically, the set of requirements will include certain terms desired by the customer, such as the customer's preferred currency, settlement date, provider or trading account. Using these terms, quote distributor 854 may determine which customer systems in the plurality of customer systems connected to online trading server 800 have expressed an interest in, or are eligible for, receiving certain kinds of price quotes, and then transmit those price quotes to those customer trading systems, as appropriate, via customer interface 885. Quote distributor 854 may also be configured to determine which customer trading systems will receive the price quotes according to preferences and requirements expressed by the providers who are providing the quotes. In preferred embodiments, the quote distributor may also be configured to automatically adjust quotes, based on the requirements and preferences expressed by both providers and customers, prior to transmitting the price quotes to each customer trading system, based on the latency determination made by latency data processor 856. The adjustment may comprise, for example, changes to the price component or the spread associated with each price quote.

Order processor 852 receives offers to deal based on the price quotes from customer trading systems 130, and rejects these offers to deal if they are received after expiration of an acceptance window established in the same fashion discussed above with reference to FIGS. 4, 5 and 6. If the offers to deal arrive before the acceptance window expires, order processor 852 may be configured to book and execute the proposed transactions and to send the appropriate notices to the parties. In some embodiments, it may be necessary or desirable to include in the online trading server one or more latency report databases (shown in FIG. 8 as bank latency report database 858 and customer latency report database 860), which are coupled to latency data processor 856, and which are configured to store and supply order processor 852 with latency data it needs to establish the appropriate acceptance windows.

The price quote lifetimes may be embodied in the price quotes as they are received from provider trading systems 810, or, alternatively, stored and retrieved from a relationship database 850 configured to hold and provide such information to other components of the system. Relationship database 850 may also contain information about active streams (i.e., which providers are currently streaming price quotes to which customers), which can be used in conjunction with information retrieved from customer latency report database 860, for example, to periodically transmit customer latency data (en masse) to provider trading systems 810. As a result, each provider will periodically receive up-to-date latency information about all of the customer trading systems to which it is streaming price quotes. Preferably, relationship database 850 also contains information relating to credit arrangements between certain providers and certain customers, and, prior to transmitting the price quotes customer trading systems 830, order processor 852 may be configured to further process offers to deal that arrive during the acceptance window according to these credit arrangements.

A system according the present invention may also include a customer interaction management console 862, coupled to the latency data processor 856, configured to allow an administrator to monitor deals, offer rejections and latency data as it is received and processed by online trading server 800. The system may also contain a status display 872, coupled to customer interaction management console 862, which is configured to display up-to-date rejection statistics and latency data.

Finally, online trading server 800 also includes an order logging database 848, which is configured to store trade-related information for booked and executed deals, as such information is created by order processor 852 in response to the timely receipt of offers to deal for valid price quotes.

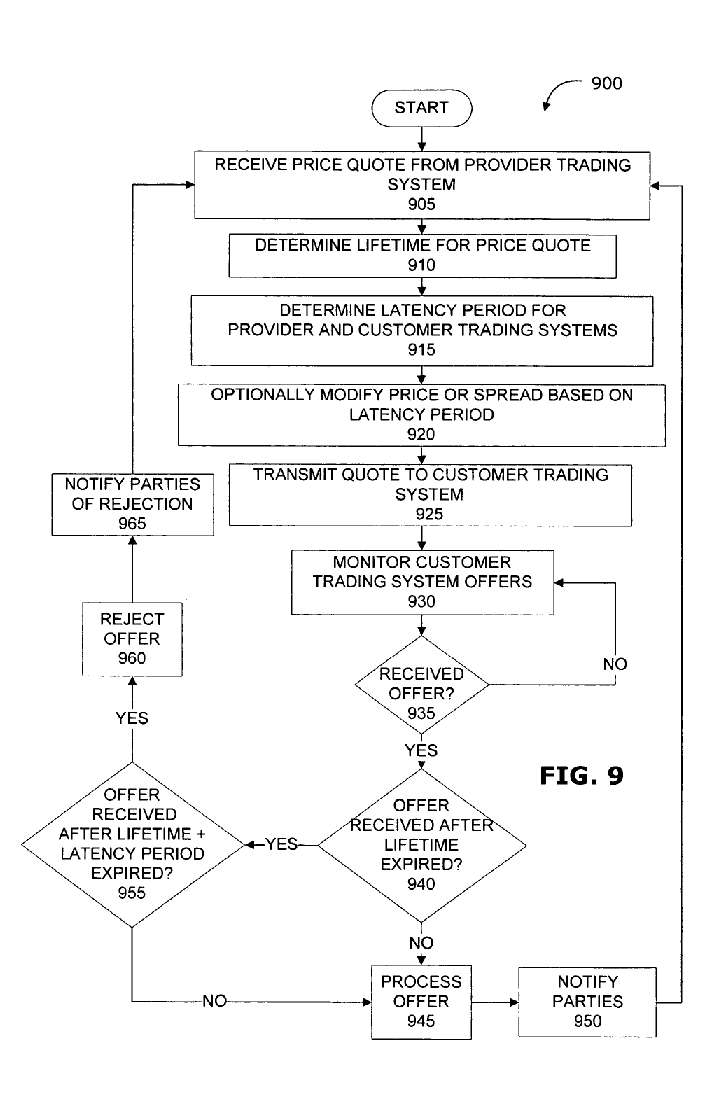

FIG. 9 contains a flow diagram 900 illustrating the steps that might be performed in embodiments of the invention, such as the online trading server depicted in FIG. 8. First, the system receives a price quote from a provider trading system (step 905) and determines the price quote's lifetime (step 910). The price quote's lifetime may be embedded in the price quote itself, or may be supplied by reference to a provider profile, a customer profile, a relationship database, or some combination of all three. Next, at step 915, the system determines the latency period for the provider trading system that sent the price quote and the customer trading system to which it is directed. Optionally, the price and spread components of the price quote may be modified, based on the latency period, to compensate the provider for holding the acceptance window for the price quote open somewhat longer than it otherwise would have in order to give the customer a better opportunity to submit a timely offer to deal (step 920). Next, at step 925, the price quote is transmitted to the customer trading system.

At this point, the system monitors incoming offers to deal (steps 930 and 935) responsive to the price quote. When an offer to deal is received, the system checks (at step 940) whether it was received after the lifetime expired. If not, then the system will allow further processing of the offer (step 945) in order to determine if the offer should be accepted. If the offer is accepted, a suitable notification is transmitted to each party (step 950). On the other hand, if it is determined at step 940 that the offer to deal was in fact received after the lifetime expired, then the system checks to whether, in addition to the lifetime, an amount of time equal to the latency period has also expired (step 955). If a window of time equal to the sum of the lifetime and the latency period has not expired, then processing continues at step 945, where the system will allow further processing of the offer. But if the offer to deal is received after the window of time equal to the sum of the lifetime and latency expires, then the system rejects the offer to deal (step 960), sends the appropriate rejection notices to the parties (step 965) and processing returns again to step 905, where the next price quote is received.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of the structures and the combination of the individual elements may be resorted to without departing from the spirit and scope of the invention.

1. A method for processing offers to trade assets on a computer network, comprising:
determining a latency for communication with a customer trading system attached to said computer network;
generating a first price quote for said customer trading system, said first price quote having a lifetime;
transmitting said first price quote to said customer trading system via said computer network at a time T;
receiving from said customer trading system an offer responsive to said first price quote; and
rejecting said offer if said offer is received after expiration of an acceptance window;
wherein said acceptance window begins at said time T and ends at said time T plus said latency plus said lifetime.

2. The method of claim 1, further comprising sending a rejection notice to said customer trading system.

3. The method of claim 1, further comprising sending a confirmation to said customer trading system if said offer is received before said acceptance window expires.

4. The method of claim 1, wherein said latency comprises a processing time required by an online trading server.

5. The method of claim 1, wherein said determining step comprises:
sending a heartbeat message to said customer trading system via said computer network, said heartbeat message being configured to elicit a response from said customer trading system;
receiving said response; and
measuring an interval of time that elapses between said step of sending said heartbeat message and said step of receiving said response.

6. The method of claim 5, wherein said heartbeat message comprises a timestamp.

7. The method of claim 6, wherein said heartbeat message further comprises a latency report.

8. The method of claim 6, wherein said measuring step comprises subtracting said timestamp from a current time.

9. The method of claim 5, further comprising storing said interval of time in a latency report.

10. The method of claim 9, further comprising storing said latency report in a latency report database.

11. The method of claim 9, further comprising sending said latency report to an online asset trading server connected to said computer network.

12. The method of claim 9, further comprising sending said latency report to said customer trading system via said computer network.

13. The method of claim 5, wherein said determining step further comprises:
sending a second heartbeat message to an online trading server via said computer network, said second heartbeat message being configured to elicit a second response from said online trading server;
receiving said second response; and
measuring a second interval of time that elapses between said step of sending said second heartbeat message and said step of receiving said second response.

14. The method of claim 1, wherein said determining step comprises:
sending a plurality of heartbeat messages to said customer trading system via said computer network, said plurality of heartbeat messages being configured to solicit a plurality of responses from said customer trading system;
receiving said plurality of responses; and
calculating, based on said plurality of responses, an average interval of time that elapses between sending each heartbeat message in said plurality of heartbeat messages and receiving each response in said plurality of responses.

15. The method of claim 14, further comprising storing said average interval of time in a latency report.

16. The method of claim 15, further comprising storing said latency report in a latency report database.

17. The method of claim 15, further comprising sending said latency report to an online asset trading server connected to said computer network.

18. The method of claim 15, further comprising sending said latency report to said customer trading system via said computer network.

19. The method of claim 1, wherein said determining step comprises receiving a latency report from an online asset trading server connected to said computer network.

20. The method of claim 1, wherein said determining step comprises receiving a latency report from said customer trading system.

21. The method of claim 1, further comprising receiving a request for quotes from said customer trading system.

22. The method of claim 21, wherein said request for quotes comprises a latency report.

23. The method of claim 1, further comprising modifying said first price quote, based on said latency, prior to transmitting said first price quote to said customer trading system.

24. The method of claim 23, wherein
said first price quote comprises a proposed price for executing said trade; and
said modifying step comprises changing said proposed price.

25. The method of claim 23, wherein
said first price quote comprises a spread; and
said modifying step comprises changing said spread.

26. The method of claim 1, further comprising:
generating a second price quote, said second price quote having said lifetime;
transmitting said second price quote to said customer trading system via said computer network at a time T-prime, wherein said time T-prime is equal to time T plus the difference between said lifetime and said latency;
receiving from said customer trading system a second offer responsive to said second price quote; and
rejecting said second offer if said second offer is received after expiration of a second acceptance window;
wherein said second acceptance window begins at said time T-prime plus said latency and ends at said time T-prime plus said latency plus said lifetime.

27. A method for trading assets on a computer network, comprising:
determining a latency for communication with a customer trading system attached to said computer network;
generating a first price quote to transmit to said customer trading system, said first price quote having a lifetime;
transmitting said first price quote to said customer trading system via said computer network at a time T;
receiving from said customer trading system an offer responsive to said first price quote; and
rejecting said offer if said offer is received prior to expiration of an acceptance window;
wherein said acceptance window begins at said time T plus said latency and ends at said time T plus said latency plus said lifetime.

28. The method of claim 27, further comprising sending a rejection notice to said customer trading system.

29. The method of claim 27, further comprising sending a confirmation notice to said customer trading system if said offer is received before said acceptance window expires.

30. The method of claim 29, further comprising executing a trade based on said offer.

31. The method of claim 27, wherein said latency comprises a processing time required by an online trading server.

32. The method of claim 27, wherein said determining step comprises:
sending a heartbeat message to said customer trading system via said computer network, said heartbeat message being configured to elicit a response from said customer trading system;
receiving said response; and
measuring an interval of time that elapses between said step of sending said heartbeat message and said step of receiving said response.

33. The method of claim 32, wherein said heartbeat message comprises a timestamp.

34. The method of claim 33, wherein said heartbeat message further comprises a latency report.

35. The method of claim 33, wherein said measuring step comprises subtracting said timestamp from a current time.

36. The method of claim 32, further comprising storing said interval of time in a latency report.

37. The method of claim 33, further comprising storing said latency report in a latency report database.

38. The method of claim 33, further comprising sending said latency report to an online asset trading server connected to said computer network.

39. The method of claim 33, further comprising sending said latency report to said customer trading system via said computer network.

40. A system for trading assets on a computer network, comprising:
a latency data processor that determines a latency for communication with a customer trading system attached to said computer network;
a quote generator that produces a first price quote, said first price quote having a lifetime, and transmits said first price quote to said customer trading system via said computer network at a time T; and
an order processor that receives from said customer trading system an offer responsive to said first price quote, and rejects said offer if said offer is received after expiration of an acceptance window;
wherein said acceptance window begins at said time T and ends at said time T plus said latency plus said lifetime.

41. The system of claim 40, wherein said order processor sends a rejection notice to said customer trading system.

42. The system of claim 40, wherein said order processor sends a confirmation notice to said customer trading system if said offer is received before said acceptance window expires.

43. The system of claim 42, wherein said order processor executes a trade based on said offer.

44. The system of claim 40, wherein said latency comprises a processing time required by an online trading server.

45. The system of claim 40, wherein said latency data processor:
sends a heartbeat message to said customer trading system via said computer network, said heartbeat message being configured to elicit a response from said customer trading system;
receives said response; and
measures an interval of time that elapses between sending said heartbeat message and receiving said response.

46. The system of claim 45, wherein said heartbeat message comprises a timestamp.

47. The system of claim 46, wherein said heartbeat message further comprises a latency report.

48. The system of claim 45, wherein said latency data processor measures said interval of time by subtracting said timestamp from a current time.

49. The system of claim 40, further comprising a latency report database.

50. The system of claim 49, wherein said latency data processor stores said latency in said latency report database.

51. The system of claim 40, wherein said latency data processor sends said latency to an online asset trading server connected to said computer network.

52. The system of claim 40, wherein said latency data processor sends said latency to said customer trading system via said computer network.

53. The system of claim 41, wherein said latency data processor:
sends a second heartbeat message to an online trading server via said computer network, said second heartbeat message being configured to elicit a second response from said online trading server;
receives said second response; and
measures a second interval of time that elapses between sending said second heartbeat message and receiving said second response.

54. The system of claim 40, wherein said latency data processor:
sends a plurality of heartbeat messages to said customer trading system via said computer network, said plurality of heartbeat messages being configured to solicit a plurality of responses from said customer trading system;
receives said plurality of responses; and
calculates, based on said plurality of responses, an average interval of time that elapses between sending each heartbeat message in said plurality of heartbeat messages and receiving each response in said plurality of responses.

55. The system of claim 54, wherein said latency data processor stores said average interval of time in a latency report.

56. The system of claim 40, wherein said latency data processor receives a latency report from an online asset trading server connected to said computer network.

57. The system of claim 40, wherein said latency data processor receives a latency report from said customer trading system.

58. The system of claim 40, wherein said order processor is configured to receive a request for quotes from said customer trading system.

59. The system of claim 58, wherein said request for quotes comprises a latency report.

60. The system of claim 40, wherein, responsive to said latency data processor, said quote generator modifies said first price quote, prior to transmitting said first price quote to said customer trading system.

61. The system of claim 60, wherein
said first price quote comprises a proposed price for executing said trade; and
said quote generator changes said proposed price.

62. The system of claim 60, wherein
said first price quote comprises a spread; and
said quote generator changes said spread.

63. The system of claim 40, wherein:
said quote generator produces a second price quote, said second price quote having said lifetime, and transmits said second price quote to said customer trading system via said computer network at a time T-prime, said time T-prime being equal to time T plus the difference between said lifetime and said latency; and
said order processor receives from said customer trading system a second offer responsive to said second price quote, and rejects said second offer if said second offer is received after expiration of a second acceptance window;
wherein said second acceptance window begins at said time T-prime plus said latency and ends at said time T-prime plus said latency plus said lifetime.

64. A system for trading assets on a computer network, comprising:
a latency data processor that determines a latency for communication with a customer trading system attached to said computer network;
a quote generator that produces a first price quote, said first price quote having a lifetime, and transmits said first price quote to said customer trading system via said computer network at a time T; and
an order processor that receives from said customer trading system an offer responsive to said first price quote, and rejects said offer if said offer is received after expiration of an acceptance window;
wherein said acceptance window begins at said time T plus said latency and ends at said time T plus said latency plus said lifetime.

65. The system of claim 64, wherein said latency comprises a processing time required by an online trading server.

66. The system of claim 64, wherein said latency data controller:
sends a heartbeat message to said customer trading system via said computer network, said heartbeat message being configured to elicit a response from said customer trading system;
receives said response; and
measures an interval of time that elapses between said sending said heartbeat message and receiving said response.

67. The system of claim 66, wherein said heartbeat message comprises a timestamp.

68. The system of claim 67, wherein said heartbeat message further comprises a latency report.

69. The system of claim 67, wherein said latency data processor measures said interval of time by subtracting said timestamp from a current time.

70. The system of claim 64, further comprising a latency report database.

71. The system of claim 70, wherein said latency data processor stores said latency in said latency report database.

72. The system of claim 64, wherein said latency data processor sends said latency to an online asset trading server connected to said computer network.

73. The system of claim 64, wherein said latency data processor sends said latency to said customer trading system via said computer network.

74. In an online trading server for trading assets on a computer network, a method for executing trades comprising:
receiving a first price quote from a provider trading system, said first quote having a lifetime;
determining a latency for communication between said provider trading system and a customer trading system connected to said computer network;
transmitting said first price quote to said customer trading system via said computer network at a time T;
receiving from said customer trading system an offer responsive to said first price quote; and
rejecting said offer if said offer is received after expiration of an acceptance window;
wherein said acceptance window begins at said time T and ends at said time T plus said latency plus said lifetime.

75. The method of claim 74, further comprising sending a rejection notice to said provider trading system.

76. The method of claim 74, further comprising sending a rejection notice to said customer trading system.

77. The method of claim 74, further comprising booking a trade based on said offer if said offer is received before said acceptance window expires.

78. The method of claim 77, further comprising sending a booking detail to said provider trading system.

79. The method of claim 74, wherein said determining step comprises receiving said latency from said provider trading system.

80. The method of claim 74, wherein said determining step comprises receiving said latency from said customer trading system.

81. The method of claim 74, wherein said determining step comprises retrieving said latency from a latency report database.

82. The method of claim 74, wherein said latency comprises a processing time required by said online trading server.

83. The method of claim 74, wherein said determining step comprises:
sending a customer heartbeat message to said customer trading system via said computer network, said customer heartbeat message being configured to elicit a response from said customer trading system;
receiving said response; and
measuring an interval of time that elapses between said step of sending said customer heartbeat message and said step of receiving said response.

84. The method of claim 83, further comprising storing said interval of time in a latency report.

85. The method of claim 84, further comprising storing said latency report in a latency report database.

86. The method of claim 83, wherein said determining step further comprises:
sending a provider heartbeat message to provider trading system via said computer network, said provider heartbeat message being configured to elicit a second response from said provider trading system;
receiving said second response; and
measuring a second interval of time that elapses between said step of sending said provider heartbeat message and said step of receiving said second response.

87. The method of claim 74, wherein said determining step comprises:
sending a plurality of customer heartbeat messages to said customer trading system via said computer network, said plurality of customer heartbeat messages being configured to solicit a plurality of responses from said customer trading system;
receiving said plurality of responses; and
calculating, based on said plurality of responses, an average interval of time that elapses between sending each customer heartbeat message in said plurality of customer heartbeat messages and receiving each response in said plurality of responses.

88. The method of claim 87, further comprising storing said average interval of time in a latency report.

89. The method of claim 88, further comprising storing said latency report in a latency report database.

90. The method of claim 88, further comprising sending said latency report to said customer trading system via said computer network.

91. The method of claim 88, further comprising sending said latency report to said provider trading system via said computer network.

92. The method of claim 83, wherein said customer heartbeat message comprises a timestamp.

93. The method of claim 92, wherein said measuring step comprises subtracting said timestamp from a current time.

94. The method of claim 74, further comprising receiving a request for quotes from said customer trading system.

95. The method of claim 94, wherein said request for quotes comprises a latency report.

96. The method of claim 74, further comprising modifying said first price quote, based on said latency, prior to transmitting said first price quote to said customer trading system.

97. The method of claim 96, wherein
said first price quote comprises a proposed price for executing said trade; and
said modifying step comprises changing said proposed price.

98. The method of claim 96, wherein
said first price quote comprises a spread; and
said modifying step comprises changing said spread.

99. The method of claim 74, further comprising:
receiving a second price quote from said provider trading system, said second price quote having said lifetime;
transmitting said second price quote to said customer trading system via said computer network at a time T-prime, said time T-prime being equal to time T plus the difference between said lifetime and said latency;
receiving from said customer trading system a second offer responsive to said second price quote; and
rejecting said second offer if said second offer is received after expiration of a second acceptance window;
wherein said second acceptance window begins at said time T-prime plus said latency and ends at said time T-prime plus said latency plus said lifetime.

100. The method of claim 99, further comprising sending a rejection notice to said provider trading system.

101. The method of claim 99, further comprising sending a rejection notice to said customer trading system.

102. In an online trading server for trading assets on a computer network, a method for executing trades, comprising:
receiving a first price quote from a provider trading system, said first price quote having a lifetime;
determining a latency for communication between said provider trading system and a customer trading system attached to said computer network;
transmitting said first price quote to said customer trading system via said computer network at a time T;
receiving from said customer trading system an offer responsive to said first price quote; and
rejecting said offer if said offer is received after expiration of an acceptance window;
wherein said acceptance window begins at said time T plus said latency and ends at said time T plus said latency plus said lifetime.

103. The method of claim 101, further comprising sending a rejection notice to said provider trading system.

104. The method of claim 101, further comprising sending a confirmation notice to said customer trading system if said offer is received before said acceptance window expires.

105. The method of claim 101, wherein said determining step comprises receiving said latency from said provider trading system.

106. The method of claim 101, wherein said determining step comprises receiving said latency from said customer trading system.

107. The method of claim 101, wherein said latency comprises a processing time required by an online trading server.

108. The method of claim 101, wherein said determining step comprises:
sending a customer heartbeat message to said customer trading system via said computer network, said customer heartbeat message being configured to elicit a response from said customer trading system;
receiving said response; and
measuring an interval of time that elapses between said step of sending said customer heartbeat message and said step of receiving said response.

109. The method of claim 108, further comprising storing said interval of time in a latency report.

110. An online trading server for executing trades on a computer network, comprising:
a customer interface for communication with a customer trading system connected to said computer network;
a provider interface that receives a first price quote from a provider trading system connected to said computer network, said first quote having a lifetime;
a latency data processor that determines a latency for communication between said provider trading system and said customer trading system;
a quote distributor that transmits said first price quote to said customer trading system via said customer interface at a time T; and
an order processor that receives from said customer trading system an offer responsive to said first price quote, and rejects said offer if said offer is received after expiration of an acceptance window;
wherein said acceptance window begins at said time T and ends at said time T plus said latency plus said lifetime.

111. The online trading server of claim 110, further comprising booking a trade based on said offer if said offer is received before said acceptance window expires.

112. The online trading server of claim 111, further comprising an order logging database to store a booking detail related to said trade.

113. The online trading server of claim 112, wherein said order processor sends said booking detail to said provider trading system.

114. The online trading server of claim 112, wherein said order processor sends said booking detail to said customer trading system.

115. The online trading server of claim 110, wherein said order processor sends a confirmation notice to said customer trading system if said offer is received before said acceptance window expires.

116. The online trading server of claim 110, further comprising a relationship database to store counterparty relationship data.

117. The online trading server of claim 110, further comprising a customer interaction console configured to monitor said latency.

118. The online trading server of claim 117, wherein said customer interaction console comprises a status display configured to display said latency.

119. The online trading server of claim 110, wherein said latency data processor receives said latency from said provider trading system.

120. The online trading server of claim 110, wherein said latency data processor receives said latency from said customer trading system.

121. The online trading server of claim 110, wherein said latency comprises a processing time required by said online trading server.

122. The online trading server of claim 110, wherein said latency data processor:
sends a customer heartbeat message to said customer trading system via said customer interface, said customer heartbeat message being configured to elicit a response from said customer trading system;
receives said response; and
measures an interval of time that elapses between said step of sending said customer heartbeat message and said step of receiving said response.

123. The online trading server of claim 122, further comprising a connection to a session monitor, residing on said customer trading system, configured to receive said customer heartbeat message from said latency data processor and to produce said response.

124. The online trading server of claim 122, wherein said latency data processor stores said interval of time in a latency report.

125. The online trading server of claim 123, further comprising a latency report database configured to store said latency report.

126. The online trading server of claim 110, wherein said latency data processor:
sends a provider heartbeat message to provider trading system via said provider interface, said provider heartbeat message being configured to elicit a second response from said provider trading system;
receives said second response; and
measures a second interval of time that elapses between said step of sending said provider heartbeat message and said step of receiving said second response.

127. The online trading server of claim 126, further comprising a connection to a session monitor, residing on said provider trading system, configured to receive said provider heartbeat message from said latency data processor and to produce said second response.

128. The online trading server of claim 110, wherein said latency data processor:
sends a plurality of customer heartbeat messages to said customer trading system via said customer interface, said plurality of customer heartbeat messages being configured to solicit a plurality of responses from said customer trading system;
receives said plurality of responses; and
calculates, based on said plurality of responses, an average interval of time that elapses between sending each customer heartbeat message in said plurality of customer heartbeat messages and receiving each response in said plurality of responses.

129. The online trading server of claim 128, further comprising a customer connection status monitor, residing on said customer trading system, configured to receive said plurality of customer heartbeat messages from said latency data processor and to produce said plurality of responses.

130. The online trading server of claim 128, wherein said average interval of time is stored in a latency report.

131. The online trading server of claim 130, further comprising a latency report database to store said latency report.

132. The online trading server of claim 130, wherein said latency data processor sends said latency report to said customer trading system via said customer interface.

133. The online trading server of claim 130, wherein said latency data processor sends said latency report to said provider trading system via said provider interface.

134. The online trading server of claim 122, wherein said customer heartbeat message comprises a timestamp.

135. The online trading server of claim 134, wherein said latency data processor measures said interval of time by subtracting said timestamp from a current time.

136. The online trading server of claim 110, wherein said quote distributor receives a request for quotes from said customer trading system.

137. The online trading server of claim 136, wherein said request for quotes comprises a latency report.

138. The online trading server of claim 110, wherein, responsive to said latency data processor, said quote distributor modifies said first price quote prior to transmitting said first price quote to said customer trading system.

139. The online trading server of claim 110, wherein:
said provider interface receives a second price quote from said provider trading system, said second price quote having said lifetime;
said quote distributor transmits said second price quote to said customer trading system via said customer interface at a time T-prime, wherein said time T-prime is equal to time T plus the difference between said lifetime and said latency; and
said order processor receives from said customer trading system a second offer responsive to said second price quote, and rejects said second offer if said second offer is received after expiration of a second acceptance window;
wherein said second acceptance window begins at said time T-prime plus said latency and ends at said time T-prime plus said latency plus said lifetime.

140. The online trading server of claim 139, wherein said order processor books a second trade based on said second offer if said second offer is received before said second acceptance window expires.

141. The online trading server of claim 140, wherein said order processor sends to said provider trading system a second booking detail related to said second trade.

142. An online trading server for executing trades on a computer network, comprising:
a customer interface for communication with a customer trading system connected to said computer network;
a provider interface that receives a first price quote from a provider trading system, said first price quote having a lifetime;
a latency data processor that determines a latency for communication between said provider trading system and said customer trading system;
a quote distributor that transmits said first price quote to said customer trading system via said customer interface at a time T; and
an order processor that receives from said customer trading system an offer responsive to said first price quote, and rejects said offer if said offer is received after expiration of an acceptance window;
wherein said acceptance window begins at said time T plus said latency and ends at said time T plus said latency plus said lifetime.

143. The online trading server of claim 142, further comprising sending a rejection notice to said provider trading system.

144. The online trading server of claim 142, further comprising sending a confirmation notice to said customer trading system if said offer is received before said acceptance window expires.

145. The online trading server of claim 142, wherein said determining step comprises receiving said latency from said provider trading system.

146. The online trading server of claim 142, wherein said determining step comprises receiving said latency from said customer trading system.
